(19) United States
(12) Patent Application Publication
(10) Pub. No.: US 2011/0109012 A1
(43) Pub. Date: May 12, 2011

(54) PATTERN FORMING METHOD

(76) Inventors: Yohko FURUTONO, Tokyo (JP); Yoshihisa KAWAMURA, Kanagawa-ken (JP)

(21) Appl. No.: 12/884,562

(22) Filed: Sep. 17, 2010

(30) Foreign Application Priority Data
Nov. 10, 2009 (JP) 2009-257547

(51) Int. Cl. B29C 59/02

(52) U.S. Cl. 264/293

(57) ABSTRACT

According to one embodiment, a pattern forming method for imprinting an imprinting surface having recess and protrusion of a template onto an imprint material provided on a target substrate is disclosed. The method includes filling a recess portion of the recess and protrusion with the imprint material. A photo-deformable layer is interposed between at least one of a location between the imprinting surface and the imprint material and a location between the target substrate and the imprint material during the filling. A configuration of the photo-deformable layer is deformable by light irradiation. The method includes curing the imprint material while the recess portion is filled with the imprint material. The method includes releasing the cured imprint material from the imprinting surface by irradiating the photo-deformable layer with light and by deforming the photo-deformable layer. The light has an intensity varying within a plane parallel to the imprinting surface.

### CROSS-REFERENCE TO RELATED APPLICATIONS

This application is based upon and claims the benefit of priority from the prior Japanese Patent Application No.2009-257547, filed on Nov. 10, 2009; the entire contents of which are incorporated herein by reference.

### FIELD

Embodiments described herein relate generally to a pattern forming method.

### BACKGROUND

In the manufacture of electronic devices having a fine structure, such as semiconductor devices and MEMS (Micro Electro Mechanical Systems), a nanoimprint method for imprinting a template to a substrate is receiving attention as a technology for forming fine patterns with high productivity.

In the nanoimprint method, an original template (mold) having a recess and protrusion pattern to be imprinted is caused to contact resin on the substrate. The resin is then cured in a state in which the resin is attuned to the shape of the recess and protrusion pattern of the template. As a result, the recess and protrusion pattern is imprinted to the resin on the substrate.

However, in the nanoimprint method, when the resin is released from the template, stress may be concentrated in certain regions of the resin, thus damaging the imprint pattern in the resin and generating defects.

In contrast, JP-A 2007-320142 (Kokai) describes a technology for obtaining favorable releasability, whereby a surface of the recesses and protrusions in the applied mold or an entirety of the recesses and protrusions is formed using a fluorinated diamond-like carbon film. However, even with this technology, the suppression of damage to the imprint pattern upon release is insufficient, and there is therefore room for improvement.

### BRIEF DESCRIPTION OF THE DRAWINGS

FIG. 1 is a flowchart illustrating a pattern forming method according to an embodiment;

FIGS. 2A to 2C are schematic cross-sectional views of a processing procedure illustrating the pattern forming method according to the embodiment;

FIGS. 3A to 3d are schematic views illustrating characteristics of a photo-deformable layer used in the pattern forming method according to the embodiment;

FIG. 4 is a flowchart illustrating a pattern forming method according to a first example;

FIGS. 5A to 5H are schematic cross-sectional views illustrating the pattern forming method according to the first example;

FIG. 6 is a flowchart illustrating a pattern forming method according to a second example;

FIGS. 7A to 7C are schematic cross-sectional views illustrating the pattern forming method according to the second example;

FIG. 8 is a flowchart illustrating a pattern forming method according to a third example;

FIGS. 9A to 9D are schematic cross-sectional views illustrating the pattern forming method according to the third example;

FIG. 10 is a flowchart illustrating a pattern forming method according to a fourth example;

FIGS. 11A to 11D are schematic cross-sectional views illustrating the pattern forming method according to the fourth example;

FIGS. 12A to 12C are schematic cross-sectional views illustrating a pattern forming method according to variation examples of the examples;

FIG. 13 is a flowchart illustrating a pattern forming method according to a fifth example;

FIGS. 14A to 14H are schematic cross-sectional views illustrating the pattern forming method according to the fifth example;

FIG. 15 is a schematic plan view illustrating an irradiation pattern of light used in the pattern forming method according to the fifth example;

FIG. 16 is a flowchart illustrating a pattern forming method according to a sixth example;

FIGS. 17A and 17B are schematic cross-sectional views illustrating the pattern forming method according to the sixth example;

FIG. 18 is a flowchart illustrating a pattern forming method according to a seventh example; and

FIGS. 19A to 19H are schematic cross-sectional views illustrating the pattern forming method according to the seventh example.

### DETAILED DESCRIPTION

In general, according to one embodiment, a pattern forming method for imprinting an imprinting surface of a template onto an imprint material provided on a major surface of a target substrate is disclosed. The imprinting surface includes recess and protrusion. The method includes filling a recess portion of the recess and protrusion with the imprint material. A photo-deformable layer is interposed between at least one location of a location between the imprinting surface and the imprint material and a location between the target substrate and the imprint material during the filling. A configuration of the photo-deformable layer is deformable by light irradiation. The method includes curing the imprint material. The recess portion is filled with the imprint material during the curing. The method includes releasing the cured imprint material from the imprinting surface by irradiating the photo-deformable layer with light and by deforming the photo-deformable layer. The light has an intensity varying within a plane parallel to the imprinting surface.

Embodiments will now be described with reference to the drawings.

The drawings are schematic or conceptual; and the relationships between the thickness and width of portions, the proportional coefficients of sizes among portions, etc., are not necessarily the same as the actual values thereof. Further, the dimensions and proportional coefficients may be illustrated differently among drawings, even for identical portions.

In the specification of the application and the drawings, components similar to those described in regard to a drawing thereinabove are marked with like reference numerals, and a detailed description is omitted as appropriate.

### EMBODIMENT

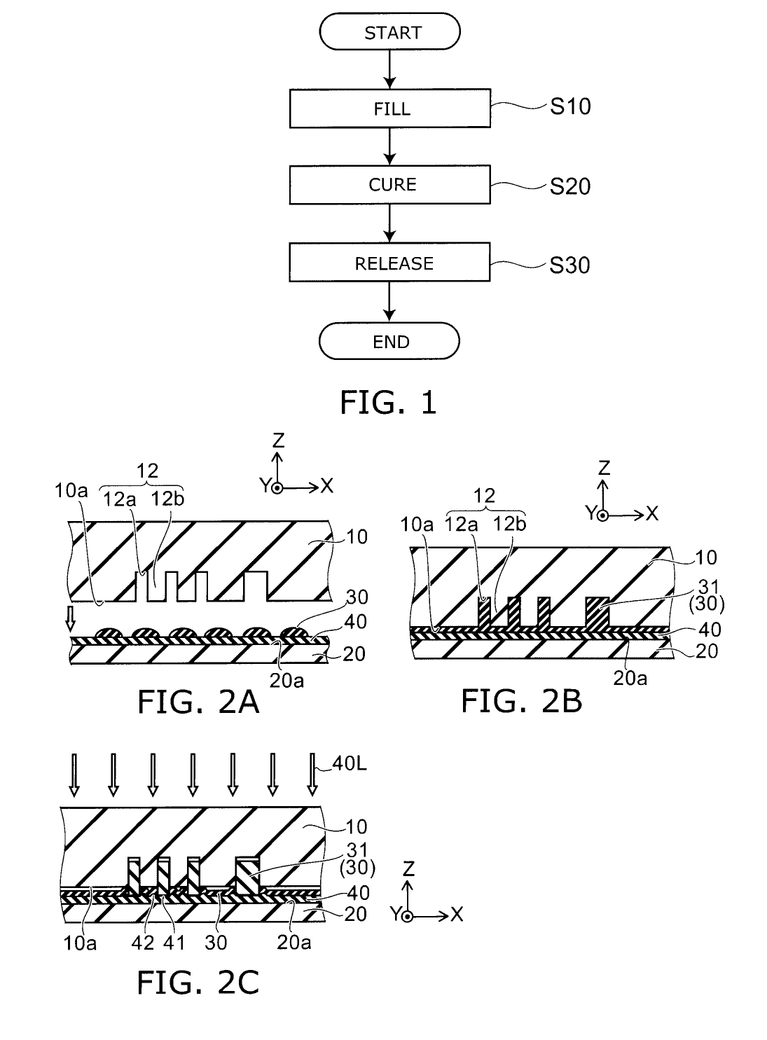

FIG. 1 is a flowchart illustrating a pattern forming method according to an embodiment.

FIG. 2 is a schematic cross-sectional view of a processing procedure illustrating a pattern forming method according to the embodiment.

As illustrated in FIG. 1 and FIGS. 2A to 2C, the pattern forming method according to the embodiment is a pattern forming method in which an imprinting surface 10a of a template 10 having the imprinting surface 10a provided with recesses and protrusions 12 is imprinted to an imprint material 30 provided on a major surface 20a of a target substrate 20.

The pattern forming method includes the processes of: filling the recess portions of the recesses and protrusions 12 with the imprint material 30 in a state in which a photo-deformable layer 40 that deforms under irradiation by light is interposed at least between the imprinting surface 10a and the imprint material 30 and/or between the target substrate 20 and the imprint material 30; curing the imprint material 30 in a state in which the imprint material 30 fills the recess portions; and releasing the cured imprint material 30 from the imprinting surface 10a by irradiating the photo-deformable layer 40 with light that has intensity varying within a plane parallel to the imprinting surface 10a and deforming the photo-deformable layer 40.

In other words, in the pattern forming method according to the embodiment, for example, as illustrated in FIG. 2A, the imprinting surface 10a of the template 10 having the imprinting surface 10a provided with the recesses and protrusions 12 is set to face the imprint material 30 provided on the major surface 20a of the target substrate 20, and, as illustrated in FIG. 2B, the imprinting surface 10a is brought into proximity or contact with the imprint material 30 so that the imprint material 30 fills the recess portions 12a of the recesses and protrusions 12(Step S10).

Subsequently, in a state in which the imprint material 30 fills the recess portions 12a, the imprint material 30 is cured (Step S20). The method used to cure the imprint material 30 is arbitrary. Thereby, the pattern of the recesses and protrusions 12 is imprinted, and the imprint material 30 is formed into a cured imprint layer 31.

Next, the cured imprint material 30 (the cured imprint layer 31) is released from the imprinting surface 10a (Step S30).

The above-described filling process of the pattern forming method according to the embodiment is performed in a state in which the photo-deformable layer 40 that deforms under irradiation with light is interposed at least one location of a location between the imprinting surface 10a and the imprint material 30 and a location between the target substrate 20 and the imprint material 30.

In a specific example illustrated in FIG. 2A and 2B, the filling is performed by causing the imprinting surface 10a to contact the imprint material 30 in a state in which the photo-deformable layer 40 is interposed between the target substrate 20 and the imprint material 30.

Then, as illustrated in FIG. 2C, the photo-deformable layer 40 is irradiated with light 40L to cause the photo-deformable layer 40 to deform, and the cured imprint material 30 (the cured imprint layer 31) is released from the imprinting surface 10a (Step S30). In this example, the irradiation with the light 40L is performed after the curing of the imprint material 30. At this time, the light used to irradiate the photo-deformable layer 40 is light that has intensity varying within a plane parallel to the imprinting surface 10a.

For the photo-deformable layer 40, for example, a material such as an azobenzene-containing polymer in which a side chain of azobenzene (a side chain including azobenzene group) is provided in a main chain of polyurethane or the like is used. When an azobenzene-containing polymer is irradiated with light, a transition from cis to trans occurs in the azobenzene. For example, in the irradiated region and non-irradiated region, fine recesses and protrusions (recess portions 41 and protrusion portions 42 shown in FIG. 2C) are formed in the surface of the azobenzene-containing polymer. Due to the fine recesses and protrusions formed when the photo-deformable layer 40 is irradiated with light, the cured imprint layer 31 that results from curing of the imprint material 30 can be released from the imprinting surface 10a, and defects at release can be suppressed.

Specifically, spaces are formed between the cured imprint layer 31 and the template 10, and the contact area between the cured imprint layer 31 and the template 10 is reduced. Air or gas of the imprint material 30 enters the spaces between the cured imprint layer 31 and the template 10, thus mitigating the difference in pressure between external portions and the spaces between the cured imprint layer 31 and the template 10 at release. This facilitates the releasing.

Thereby, it is possible to provide a nanoimprint-type pattern forming method in which the number of defects at release is suppressed.

Because the releasing is facilitated, no large external force is required when removing the template 10, even in the case of high-density patterns. It is therefore possible to provide a pattern forming method that is also applicable to a high-density pattern.

The material used for the photo-deformable layer 40 is not limited to the above-described material. Any material may be used as long as recesses and protrusions of a surface thereof change depending on the intensity of irradiated light (e.g., the volume is partially changed).

Here, for ease of description, an X, Y, Z coordinate system is introduced.

A direction perpendicular to the imprinting surface 10a of the template 10 is defined as a Z-axis direction. One direction perpendicular to the Z-axis direction is defined as an X-axis direction. A direction perpendicular to the X-axis direction and the Z-axis direction is defined as a Y-axis direction.

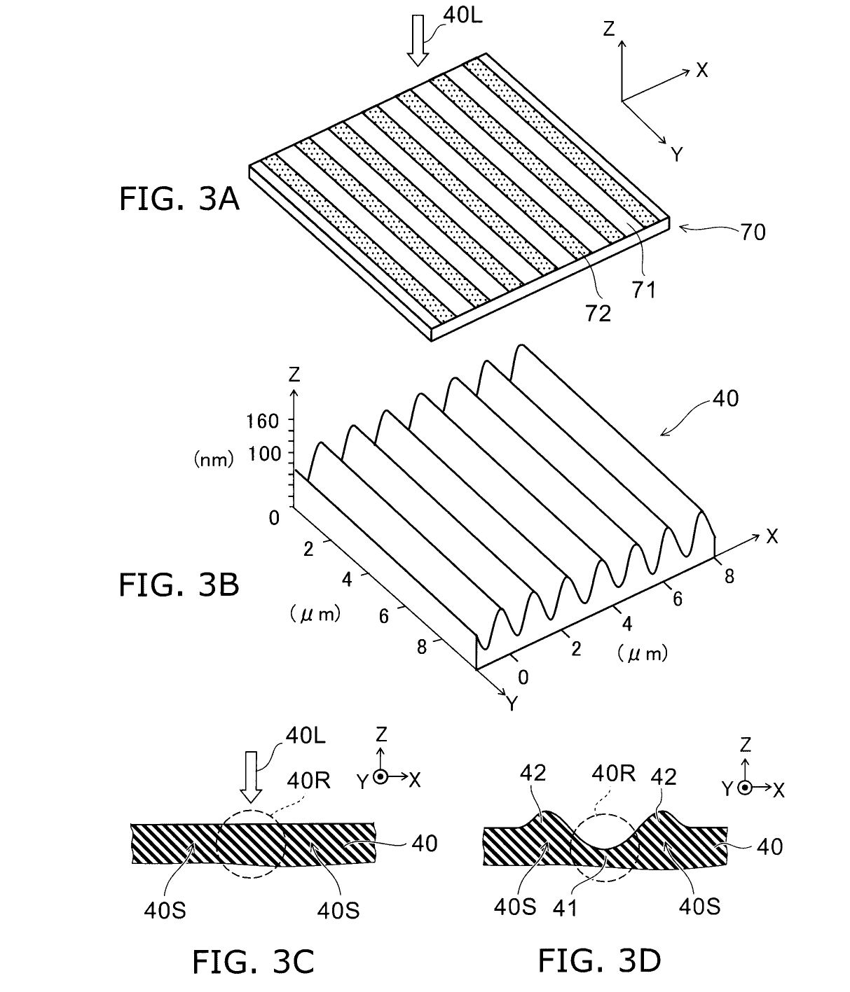

FIGS. 3A to 3D are schematic views illustrating characteristics of a photo-deformable layer used in the pattern forming method according to the embodiment.

Specifically, FIG. 3A is a schematic perspective view illustrating the configuration of a filter 70 used in irradiating the photo-deformable layer 40 with the light 40L. FIG. 3B is an image illustrating the photo-deformable layer 40 as observed with an AMF (atomic force microscope). FIG. 3C is a schematic cross-sectional view illustrating the form of the photo-deformable layer 40 prior to irradiation with the light 40L. FIG. 3D is a schematic cross-sectional view illustrating the form of the photo-deformable layer 40 after irradiation with the light 40L.

As illustrated in FIG. 3A, for example, the filter 70 having light-passing portions 71 and light-blocking portions 72 are used in irradiating the photo-deformable layer 40 with the light 40L. For example, each stripe-shaped light-blocking portion 72 is arranged between two adjacent ones of multiple stripe-shaped light-passing portions 71. The filter 70 is, for example, silica. Such configuration is obtained by forming, for example, a Cr film on a major surface of the filter 70 and patterning the Cr film into a band form. With the light-passing portions 71 and the light-blocking portions 72, the filter 70 functions as a diffraction grating. By passing through such a filter 70, a configuration in which a stripe-shaped region having a high intensity of light and a stripe-shaped region having a low intensity of light are alternate is obtained in the light 40L.

As illustrated in FIG. 3B, stripe-shaped protrusion portions 42 and stripe-shaped recess portions 41 are formed on a surface of the photo-deformable layer 40 by irradiating the photo-deformable layer 40 with such light 40L.

In other words, as illustrated in FIG. 3C, for example, prior to irradiating with the light 40L, the surface of the photo-deformable layer 40 is flat.

Then, as illustrated in FIG. 3D, when the photo-deformable layer 40 is locally irradiated with the light 40L, the photo-deformable layer 40 becomes recessed and the recess portions 41 are formed in light-irradiated regions 40R irradiated with the light 40L. In adjacent regions 40S located adjacent to the light-irradiated regions 40R, the photo-deformable layer 40 expands to form the protrusion positions 42. Specifically, for example, the photo-deformable material of the light-irradiated regions 40R is shifted towards the adjacent regions 40S, making the light-irradiated regions 40R into recesses and the adjacent regions 40S into protrusions. Alternatively, for example, the photo-deformable material of the light-irradiated regions 40R is constricted so that recesses are formed in the light-irradiated regions 40R, and the adjacent regions 40S are expand to form protrusions. The reverse of these characteristics is obtained depending on the photo-deformable materials. The following describes a case in which the recess portions 41 are formed in the light-irradiated regions 40R and the protrusion portions 42 are formed in the adjacent regions 40S.

The light 40L is a light that has a wavelength absorbed by the photo-deformable layer 40, and the peak wavelength of the light 40L is, for example, from 300 nm (nanometers) to 500 nm. A difference in height between such recess portion 41 and protrusion portion 42 (distance between a top portion and a bottom portion) caused by light irradiation is, for example, from 5 nm to 100 nm. The intensity of the light 40L for deforming the photo-deformable layer 40 varies depending on the materials and the like used for the photo-deformable layer 40, but is, for example, from 5 mW/cm² to 100 mW/cm². Additionally, a time required for the deformation of the photo-deformable layer 40 (formation of the recess portions 41 and the protrusion portions 42) varies depending on various characteristics such as the material used for the photo-deformable layer 40 and the conditions of the irradiation with the light 40L, but is from a few seconds to a few minutes.

Thus, by the light 40L with intensity varying within an X-Y plane (a plane parallel to the imprinting surface 10a), recesses and protrusions (the recess portions 41 and the protrusion portions 42) are formed in the photo-deformable layer 40. For example, if the entire surface of the photo-deformable layer 40 is irradiated with light, the recesses and protrusions will disappear, causing the surface of the photo-deformable layer 40 being restored to an initial flat state thereof (e.g., a state illustrated in FIG. 3C). Moreover, heating the photo-deformable layer 40 also causes the recesses and protrusions to disappear, resulting in the surface of the photo-deformable layer 40 being restored to the initial flat state thereof.

In this specific example, a substrate made of silica or the like and has recesses and protrusions 12 provided on a surface thereof (the imprinting surface 10a) is used for the template 10. The recesses and protrusions 12 have a pattern form of a form to be imprinted on the imprint material 30 of the target substrate 20.

For the target substrate 20, a substrate or the like provided with at least one of, for example, a semiconductor wafer, a semiconductor layer, a conducting layer, and an insulating layer is used.

Various resins, for example, are used for the imprint material 30, and a light-curable resin is used in this specific example. A thermosetting resin may also be used for the imprint material 30.

Examples according to the embodiment will be described hereafter.

### FIRST EXAMPLE

In a pattern forming method of a first example according to the embodiment, filling the imprint material 30 in the recess portions 12b of the template 10 (Step 10) is performed by bringing the imprinting surface 10a into contact with the imprint material 30 in a state in which the photo-deformable layer 40 is interposed between the target substrate 20 and the imprint material 30.

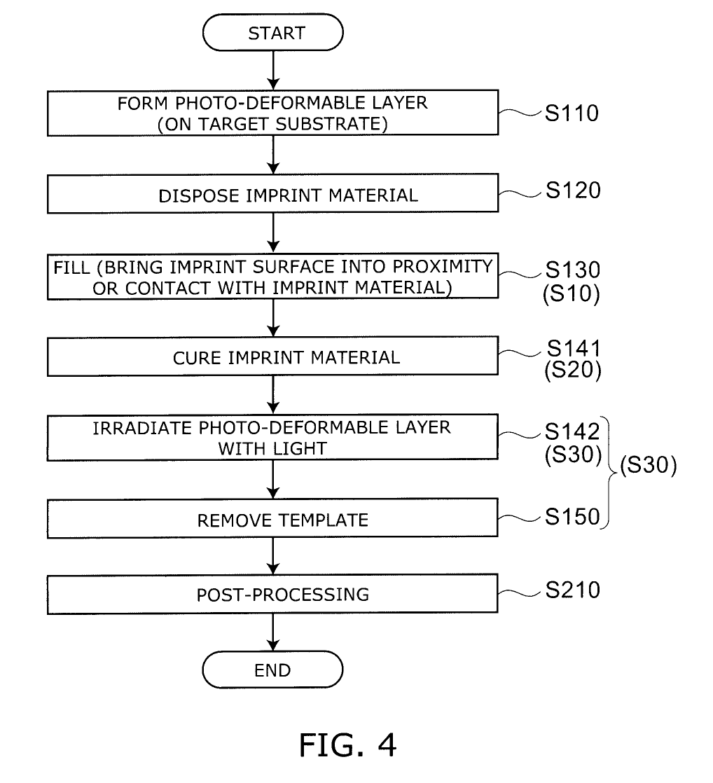

FIG. 4 is a flowchart illustrating the pattern forming method according to the first example.

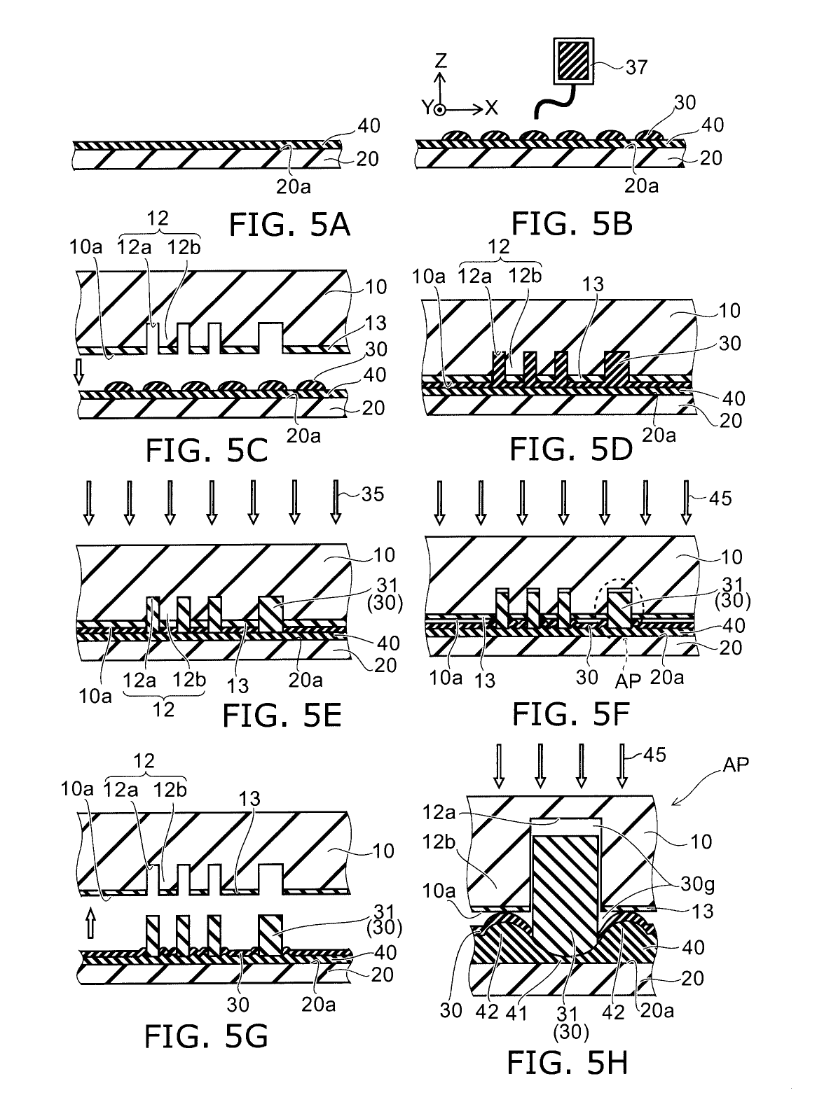

FIGS. 5A to 5H are schematic cross-sectional views illustrating the pattern forming method according to the first example.

More specifically, FIGS. 5A to 5G are schematic cross-sectional views of a processing procedure, and FIG. 5H is an enlarged schematic cross-sectional view of a portion AP of FIG. 5F.

As illustrated in FIG. 4 and FIG. 5A, the photo-deformable layer 40 is formed on the major surface 20a of the target substrate 20 (Step S110). For example, an azobenzene-containing polymer is used for the photo-deformable layer 40. The thickness of the photo-deformable layer 40 is, for example, approximately 20 nm. The absorption wavelength of the azobenzene-containing polymer is, for example, approximately 400 nm. For example, when the azobenzene-containing polymer is irradiated with light having a peak wavelength of approximately 400 nm at an intensity of approximately 80 mW/cm² for approximately 3 minutes, recesses and protrusions with a height difference of approximately 30 nm are formed.

The photo-deformable layer 40 is formed on the target substrate 20 by coating the target substrate 20 with a photo-deformable material (e.g., an azobenzene-containing polymer and the like) that forms the photo-deformable layer 40 on the target substrate 20. The photo-deformable material coating is performed by, for example, spin-coating. However, in the embodiment, a coating method for coating the photo-deformable material on the target substrate 20 is arbitrary, and printing methods including inkjet printing, and the like, may be used.

Subsequently, as illustrated in FIG. 4 and FIG. 5B, the imprint material 30 is disposed on the photo-deformable layer 40 of the target substrate 20 (Step S120). A light-curable resin material such as an acryl, epoxy or the like is used for the imprint material 30. The imprint material 30 is disposed by using, for example, the inkjet printing method. By using the inkjet printing method, the imprint material 30 can be selectively disposed on desired locations in the major surface 20a of the target substrate 20. In this way, when sequentially imprinting the imprinting surface 10a of the template 10 in the major surface 20a of the target substrate 20, variation in the time taken from disposing the imprint material 30 to imprinting (proximity or contact) can be suppressed, thus stabilizing the process. Further, the material utilization efficiency of the imprint material 30 is also improved. However, in the embodiment, the method for coating the imprint material 30 on the target substrate 20 (on the photo-deformable layer 40) is arbitrary. The imprint material 30 is a liquid when coating, and becomes solid by irradiation with light, for example.

Subsequently, as illustrated in FIG. 5C, the imprinting surface 10a of the template 10 is set to face the imprint material 30 provided on the major surface 20a of the target substrate 20. The recesses and protrusions 12 are provided in the imprinting surface 10a of the template 10. The recesses and protrusions 12 include recess portions 12a and protrusion portions 12b. In this specific example, a light-blocking film 13 is provided on the protrusion portions 12b. A Cr film, for example, is used for the light-blocking film 13. Specifically, the Cr film is provided on a major surface of a substrate (e.g., a silica substrate) forming the template 10, and the pattern of the recesses and protrusions 12 is formed in the Cr film by, for example, electron beam lithography. By using the Cr film as a mask, the substrate is dry-etched to form the recesses and protrusions 12. The Cr film used as a mask during the dry etching is used for the light-blocking film 13.

Thus, in the case where the light-blocking film 13 is provided on the protrusions 12b, the depth (length along the Z-axis direction) of the recesses and protrusions imprinted on the template 10 is found by adding the thickness of the light-blocking film 13 to the depth of the recess portions 12a. The actual recesses and protrusions on the template 10 are produced by a height difference between bottom surfaces of the recesses 12a and the surface of the light-blocking film 13 (the surface on a side opposite to the protrusions 12b). Hence, in the case where the light-blocking film 13 is provided on the protrusions 12b, the light-blocking film 13 can be taken as being included in the template 10 and the imprinting surface 10a of the template 10 can be taken as including the surface of the light-blocking film 13.

Then, as illustrated in FIG. 4 and FIG. 5D, the imprinting surface 10a is brought into proximity or contact with the imprint material 30 (Step S130). In this example, the imprinting surface 10a is brought into contact with the imprint material 30. As a result, the imprint material 30 fills the recess portions 12a of the recesses and protrusions 12 (Step S10). The filling is conducted in a state in which the photo-deformable layer 40 is interposed between the target substrate 20 and the imprint material 30.

Then, as illustrated in FIG. 4 and FIG. 5E, the imprint material 30 is cured in a state in which the imprint material 30 fills the recess portions 12a (Step S141 and Step S20). Specifically, the imprint material 30 is irradiated with light 35 having, for example, a peak wavelength of approximately 300 nm that cures the imprint material 30 at energy of, for example, approximately 200 mJ/cm². The imprint material 30 is cured by irradiating with the light 35 to form a cured imprint layer 31.

Thereby, the pattern of the recesses and protrusions 12 is imprinted, and the imprint material 30 is formed into the cured imprint layer 31.

In other words, the cured imprint layer 31 is formed by irradiating the imprint material 30 filled in the recess portions 12a of the template 10 with the light 35. At this time, since portions of the imprint material 30 in contact with the protrusion portions 12b of the template 10 are shielded from the light 35 by the light-blocking film 13, the portions of the imprint material 30 are not irradiated by the light 35. Thus, the imprint material 30 of these portions remains in the initial imprint material 30 state (liquid state) thereof.

Then, as illustrated in FIG. 4 and FIG. 5F, after curing the imprint material 30 to form the cured imprint layer 31, the photo-deformable layer 40 is irradiated with light 45. The light 45 has a wavelength and energy that cause the photo-deformable layer 40 to deform. The light 45 has, for example, a peak wavelength of approximately 400 nm and an intensity of approximately 80 mW/cm². This light 45 is light that has intensity varying within a plane parallel to the imprinting surface 10a (the X-Y plane). In this specific example, the light 45 is blocked by the light-blocking film 13 on the protrusion portions 12b of the template 10, and the light 45 is transmitted to the recess portions 12a. Thereby, the intensity of the light 45 varies within the X-Y plane.

As described above, in this example, the imprint material 30 is a photo-curable resin. The curing of the imprint material 30 is performed by irradiating the imprint material 30 with light. The light 35 used to irradiate the imprint material 30 in the curing process of the imprint material 30 and the light 45 used to irradiate the photo-deformable layer 40 in the deformation process of the photo-deformable layer 40 have different wavelength components. In other words, the wavelength characteristics of the light 35 and the wavelength characteristics of the light 45 are mutually different. For example, the peak wavelength of the light 35 and the peak wavelength of the light 45 are mutually different. Even in the case where the peak wavelength of the light 35 and the peak wavelength of the light 45 are mutually the same, the spectra of each of the lights is different and each of the lights has a different wavelength distribution characteristics of intensity.

As illustrated in FIG. 5H, recess portions 41 and protrusion portions 42 are formed in the photo-deformable layer 40 by irradiating with the light 45. Specifically, on the imprinting surface 10a of the template 10, the intensity of the light 45 is high in the recess portions 12a where the light-blocking film 13 is not provided, and, for example, portions of the photo-deformable layer 40 opposing the recess portions 12a become recessed, and the recess portions 41 are formed. In addition, portions of the photo-deformable layer 40 opposing the protrusion portions 12b adjacent to the recess portions 12a of the template 10 expand, and the protrusion portions 42 are formed.

Top surfaces of the protrusion portions 42 of the photo-deformable layer 40 push the imprinting surface 10a of the template 10 upward (a direction from the target substrate 20 toward the template 10). In this specific example, the protrusion portions 42 of the photo-deformable layer 40 push the light-blocking film 13 of the imprinting surface 10a of the template 10 upward via the imprint material 30. Then, the cured imprint layer 31 inside the recess portions 12a of the template 10 is pulled downward (a direction from the template 10 toward the target substrate 20) by the recess portions 41 of the photo-deformable layer 40.

Thereby, the template 10 and the cured imprint layer 31 (the imprint material 30) are separated from each other from a closely-attached state without applying an external mechanical force. Specifically, the cured imprint layer 31 is released from the recess portions 12a of the template 10 and the cured imprint material 30 is released from the protrusion portions 12b of the template 10. In this way, the photo-deformable layer 40 is irradiated with the light 45; the photo-deformable layer 40 is deformed; and the cured imprint material 30 (the cured imprint layer 31) is released from the imprinting surface 10a (Step S30).

In this specific example, the imprint material 30 that contacts the protrusion portions 12b of the template 10 is not irradiated with the light 35 due to the light-blocking film 13 and thus remains in a liquid state. Hence, when the cured imprint layer 31 is released from the template 10, spaces formed between the template 10 and the cured imprint layer 31 are filled with the liquid or an imprint material gas 30g, which is produced by evaporation of the imprint material 30. Therefore, it is possible to suppress difficulty of release caused by gas pressure in the spaces being lower than the external pressure, and the release is more easily performed.

Further, since the recess portions 41 and the protrusion portions 42 are formed by deformation of the photo-deformable layer 40 along the pattern form of the recesses and protrusions 12 of the template 10 (form within the X-Y plane), a release force acts uniformly upon each of the recesses and protrusions 12 when releasing the cured imprint layer 31 from the template 10. Across the entire imprinting surface 10a of the template 10, the release is more easily performed.

Then, as illustrated in FIG. 4 and FIG. 5G, the template 10 is removed (Step S150). At this time, the cured imprint layer 31 is released from the template 10 as a result of the deformation of the photo-deformable layer 40. Hence, the template 10 can be removed without applying a large mechanical force. Therefore, damage to the cured imprint layer 31 when removing the template 10 is suppressed, and the occurrence of defects is suppressed. Specifically, the deformation of the photo-deformable layer 40 generates a force to push up the template 10, i.e., a release force, at the pattern edge (boundary between the recess portions 12a and the protrusion portions 12b) of the template 10, thereby accelerating release. As a result, the force required to remove the template 10 is reduced, and the occurrence of defects is suppressed.

Step S30 (a process of releasing the cured imprint material from the imprinting surface 10a by deforming the photo-deformable layer 40 through irradiation of the photo-deformable layer 40 with light 40L) may include Step S150 (a process of separating the template 10 and the target substrate 20 to a distance greater than the depth of the recesses and protrusions 12 using an external mechanical force) in addition to Step S142 (a process of separating the cured imprint layer 31 from the template 10 by deformation of the photo-deformable layer 40).

As illustrated in FIG. 4, a post-processing (Step 210) in which the film thickness of the cured imprint layer 31 (and photo-deformable layer 40) after imprinting is reduced to expose a part of the major surface 20a of the target substrate 20 can be performed.

Specifically, during imprinting, the protrusion portions 12b of the template 10 and the target substrate 20 are not in full contact, and the imprint material 30 (the cured imprint layer 31) and photo-deformable layer 40 are present between the protrusion portions 12b and the target substrate 20. Therefore, in the state illustrated in FIG. 5G, the imprint material 30 (the cured imprint layer 31) and photo-deformable layer 40 remain as a residual film in regions corresponding to the protrusion portions 12b of the template 10. To remove the residual film, the post-processing is performed in which a part of the major surface 20a of the target substrate 20 is exposed. The post-processing may include various types of anisotropic dry etching, irradiation with ultraviolet light, and the like.

In the state illustrated in FIG. 5G, recesses and protrusions have been formed in the surfaces of the photo-deformable layer 40 and the imprint material 30 as a result of the deformation of the photo-deformable layer 40. However, because the photo-deformable layer 40 that is not covered by the cured imprint layer 31 and the imprint material 30 are removed in the above-described post-processing, the formation of such recesses and protrusions does not present a practical problem.

### COMPARATIVE EXAMPLE

In a pattern forming method according to a comparative example, the photo-deformable layer 40 is not provided. Except for this, the pattern forming method is the same as that of the first example.

In the comparative example, because the photo-deformable layer 40 is not provided, spaces are not formed between the cured imprint layer 31 filling the recess portions 12a of the template 10 and the recess portions 12a after the imprint material 30 illustrated in FIG. 5E is cured to form the cured imprint layer 31. Thus, the cured imprint layer 31 and the recess portions 12a are closely attached. Therefore, at release, the template 10 and the target substrate 20 are pulled apart by an external mechanical force.

At this time, due to deformation of the template 10 and variation in release speeds in the plane parallel to the imprinting surface 10a of the template 10, portions of stress concentration are generated in the cured imprint layer 31. These stress concentrations result in defects, such as, for example, breakdown of the cured imprint layer 31 and a portion of the cured imprint layer 31 being left in the recess portions 12a of the template 10. Moreover, in a case where a high-density pattern is formed, the density of the recesses and protrusions 12 of the template 10 is increased. As a result, the contact area between, for example, the recess portions 12a and the cured imprint layer 31 increases, a very large external mechanical force is required at release, and the release becomes difficult.

In contrast, according to the pattern forming method according to the embodiment (e.g., the first example), the use of the photo-deformable layer 40 and the deformation of the photo-deformable layer 40 to form the recess portions 41 and protrusion portions 42 result in the cured imprint layer 31 of the template 10 being pushed up and spaces being formed between the recess portions 12a of the template 10 and the cured imprint layer 31. This accelerates release and suppresses the occurrence of defects at release. Further, because release is accelerated by the deformation of the photo-deformable layer 40, a large external force is not required when removing the template 10 even in a case of the formation of high-density patterns. Thus, this method can also meet the high-density patterns

Moreover, as described above, at release, the imprint material 30 under the light-blocking film 13 evaporates and fills a space between the template 10 and the cured imprint layer 31. As a result, the target substrate 20 is automatically released from the template 10, further facilitating release.

The various steps described in relation to this example can be interchanged where it is technically possible to do so. It is also possible to perform a plurality of steps simultaneously.

### SECOND EXAMPLE

In a pattern forming method of a second example according to the embodiment, the light used to cure imprint material 30 and the light used to deform the photo-deformable layer 40 have the same wavelength.

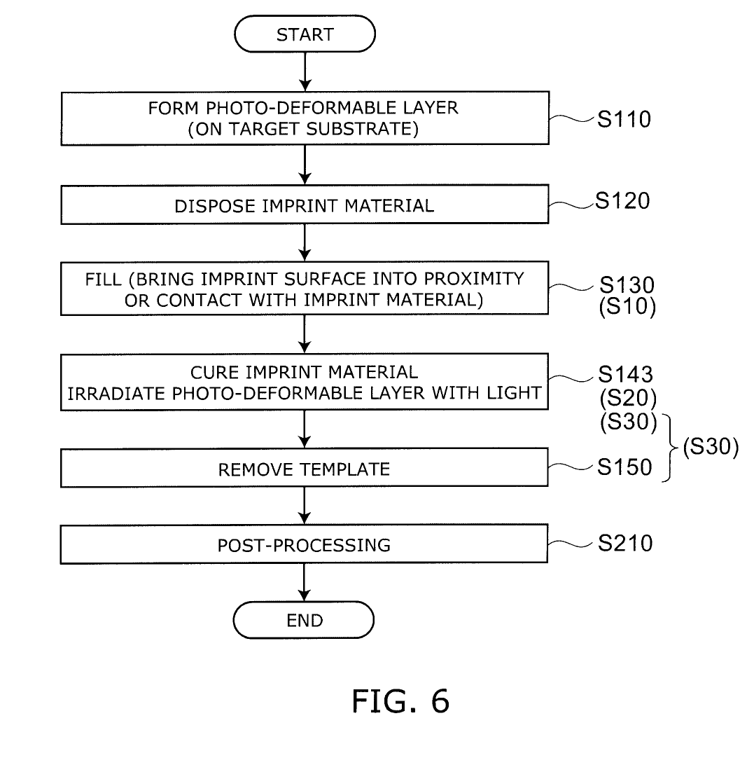

FIG. 6 is a flowchart illustrating the pattern forming method according to the second example.

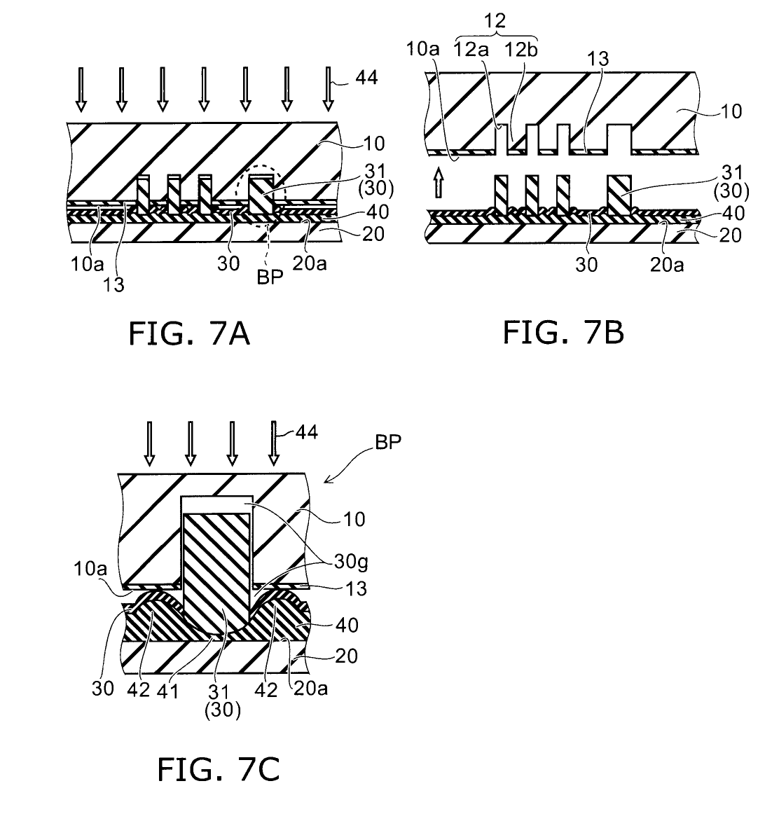

FIGS. 7A to 7C are schematic cross-sectional views illustrating the pattern forming method according to the second example.

Specifically, FIGS. 7A and 7B are schematic cross-sectional views of a processing procedure, and FIG. 7C is an enlarged schematic cross-sectional view of a portion BP in FIG. 7A.

As illustrated in FIG. 6, in the pattern forming method according to the second example, the forming of the photo-deformable layer 40 on the target substrate 20 (Step 5110), the disposing of the imprint material (Step S120), and the contact between and filling of the imprinting surface 10a and the imprint material 30 (Step 5130 and Step S10) are the same as those of the first example illustrated in FIGS. 5A to 5D. Thus, a description thereof will be omitted.

In the second example, a material which has an absorption wavelength of around 300 nm and is cured with irradiation energy of 200 mJ/cm² is used for the imprint material 30. On the other hand, a material which has an absorption wavelength of around 400 nm and is deformed by irradiation energy of 200 mJ/cm² is used for the photo-deformable layer 40.

In the pattern forming method according to the second example as illustrated in FIG. 6 and FIG. 7A, the imprint material is cured by irradiation with the light 44 and the photo-deformable layer 40 is irradiated with the light 44 in a state in which the imprinting surface 10a and the imprint material 30 are brought into contact and the imprint material 30 fills the recess portions 12a (Step S143).

The peak wavelength of the light 44 at this time is, for example, approximately 300 nm, and the intensity in the image plane of the light 35 is 200 mW/cm². The imprint material 30 is cured for approximately one second by irradiation with the light 35, forming the cured imprint layer 31 (Step S20). On the other hand, the photo-deformable layer 40 is deformed in approximately one minute by the irradiation with the light 35.

Specifically, as illustrated in FIG. 7C, the recess portions 41 and the protrusion portions 42 are formed in the photo-deformable layer 40. As a result, the cured imprint layer 31 is released from the template 10 without applying an external mechanical force. Specifically, the cured imprint layer 31 is released from the recess portions 12a of the template 10 and the imprint material 30 is released from the protrusion portions 12b of the template 10. In this way, the photo-deformable layer 40 is irradiated with the light 45, the photo-deformable layer 40 is deformed, and the cured imprint material 30 (the cured imprint layer 31) is released from the imprinting surface 10a (Step S30).

Then, as illustrated in FIG. 6 and FIG. 7B, the template 10 is removed (Step S150). Since the cured imprint layer 31 (the imprint material 30) is separated from the template 10 as a result of the deformation of the photo-deformable layer 40, the two members can be separated from each other without applying a large external mechanical force. Thus, when the template 10 is removed, the cured imprint layer 31 is not damaged, and the occurrence of defects is suppressed.

The post-processing (Step S210) is performed as necessary.

In this specific example, Step S20 of curing the imprint material 30 and Step S30 of irradiating the photo-deformable layer 40 with the light 44 are started simultaneously. Step S20 comes to an end first, and Step S30 is continued after the end of Step S20. The photo-deformable layer 40 is irradiated with the light 44, and the cured imprint material 30 (the cured imprint layer 31) is thereby released from the imprinting surface 10a, bringing Step S30 to an end. Alternatively, Step S30 ends after the removal of the template (Step S150). In other words, at least part of the curing process (Step S20) is performed simultaneously with at least part of the releasing process (Step S30).

In the pattern forming method according to the second example, the photo-deformable layer 40 is used. By forming the recess portions 41 and the protrusion portions 42 in the photo-deformable layer 40, spaces are formed between the recess portions 12a of the template 10 and the cured imprint layer 31. Thereby, release is accelerated, and defects at release can be suppressed. Moreover, a large external mechanical force is not required when removing the template 10, and this method can be applied to high-density patterns. Also, at release, the imprint material 30 under the light-blocking film 13 evaporates, causing automatic release of the target substrate 20 from the template 10, and further facilitating release.

This example has an advantage which the light used to cure the imprint material 30 and the light used to deform the photo-deformable layer 40 have the same wavelength (the light 44). Therefore, a manufacturing device can be simplified.

### THIRD EXAMPLE

In a pattern forming method of a third example according to the embodiment, unlike the first example, a process is added after the removal of the template 10 in which the photo-deformable layer 40 is irradiated with light to eliminate the recesses and protrusions of the photo-deformable layer 40.

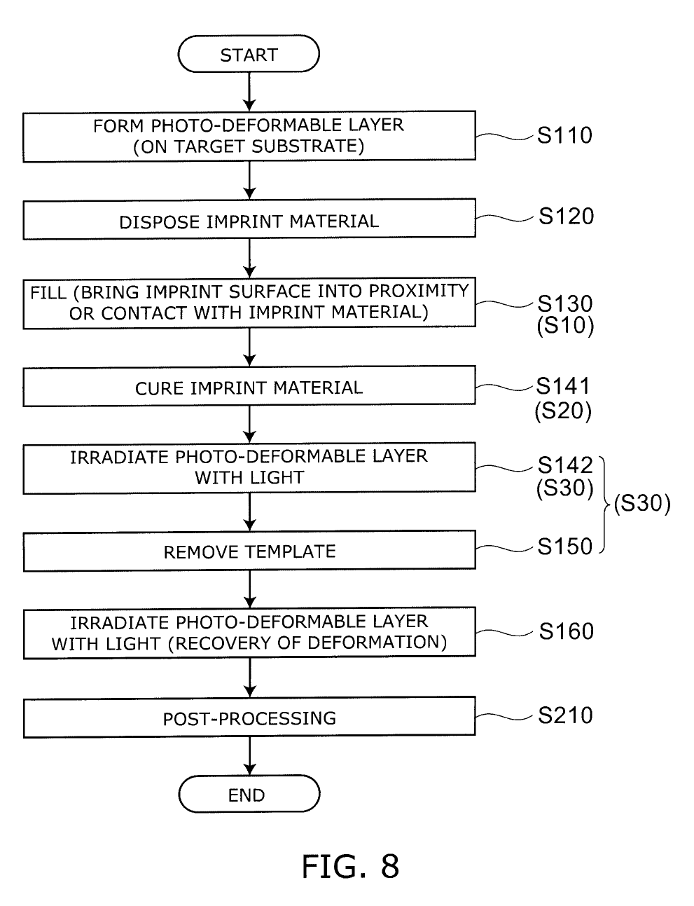

FIG. 8 is a flowchart illustrating the pattern forming method according to the third example.

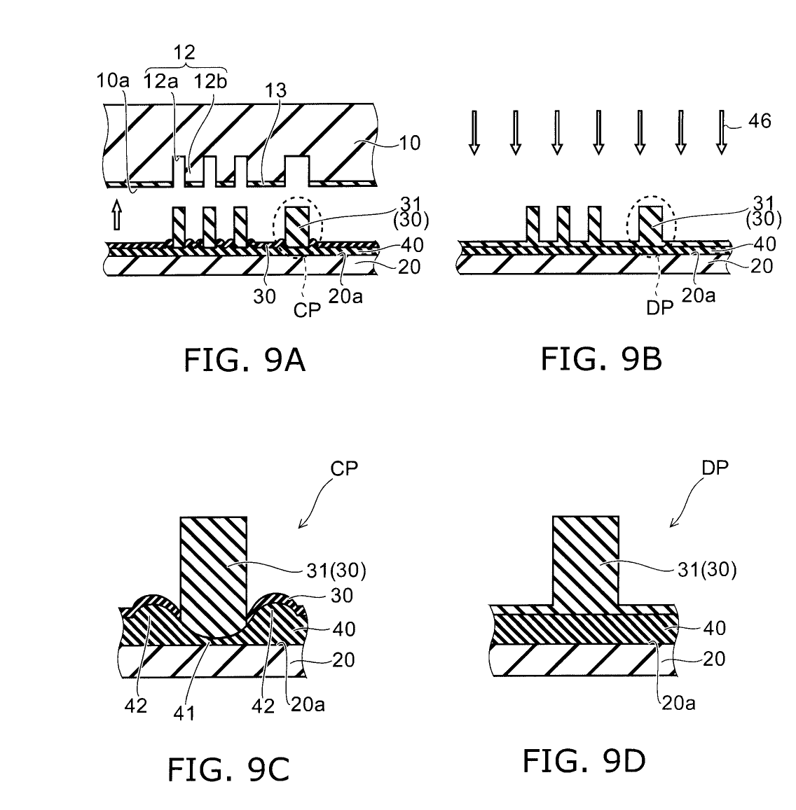

FIGS. 9A to 9D are schematic cross-sectional views illustrating the pattern forming method according to the third example.

Specifically, FIGS. 9A and 9B are schematic cross-sectional views of a processing procedure, FIG. 9C is an enlarged schematic cross-sectional view of a portion CP in FIG. 9A, and FIG. 9D is an enlarged schematic cross-sectional view of a portion DP in FIG. 9B.

As illustrated in FIG. 8, in the pattern forming method according to the third example, the forming of the photo-deformable layer 40 on the target substrate 20 (Step S110), the disposing of the imprint material (Step S120), the contact between and filling of the imprinting surface 10a and the imprint material 30 (Step S130), the curing of the imprint material 30 and the irradiation of the photo-deformable layer 40 with the light 45 (Step S142), and the removal of the template 10 (Step 150) are the same as those of the first example. Thus, a description thereof will be omitted.

In the pattern forming method according to the third example, after the removal of the template 10 (Step S150) illustrated in FIG. 8 and FIG. 9A, the photo-deformable layer 40 is irradiated with light 46 (Step S160) as shown in FIG. 9B. The entire surface of the photo-deformable layer 40 is irradiated with the light 46 via the cured imprint layer 31 or the imprint material 30. The light 46 is light that has, for example, a peak wavelength of approximately 400 nm and an intensity of 50 mW/cm². The irradiation is performed for three minutes over the entire surface of the photo-deformable layer 40, for example. As a result, the recesses and protrusions (the recess portions 41 and the protrusion portions 42) in the photo-deformable layer 40 formed in Step S142 are removed, the deformation of the photo-deformable layer 40 is recovered, and the photo-deformable layer 40 becomes substantially flat. Any residual imprint material 30 that has yet to be cured is subsequently cured.

Specifically, as illustrated in FIG. 9C, after Step S150, the recess portions 41 and the protrusion portions 42 remain in the photo-deformable layer 40. In Step S160, the photo-deformable layer 40 is restored to the initial flat state by the irradiation with the light 46. This process improves the precision in the cured imprint layer 31. However, as described above, Step S160 may not be performed. The practice of Step S160 is arbitrary.

In the pattern forming method according to the third example as well, the photo-deformable layer 40 is used. By forming the recess portions 41 and the protrusion portions 42 in the photo-deformable layer 40, spaces are formed between the recess portions 12a of the template 10 and the cured imprint layer 31. Thereby, release is accelerated, and defects at release are suppressed.

In this case as well, the post-processing (Step S210) may further be performed.

### FOURTH EXAMPLE

In a pattern forming method of a fourth example according to the embodiment, unlike the third example, a heating process is used to restore the deformation of the photo-deformable layer 40.

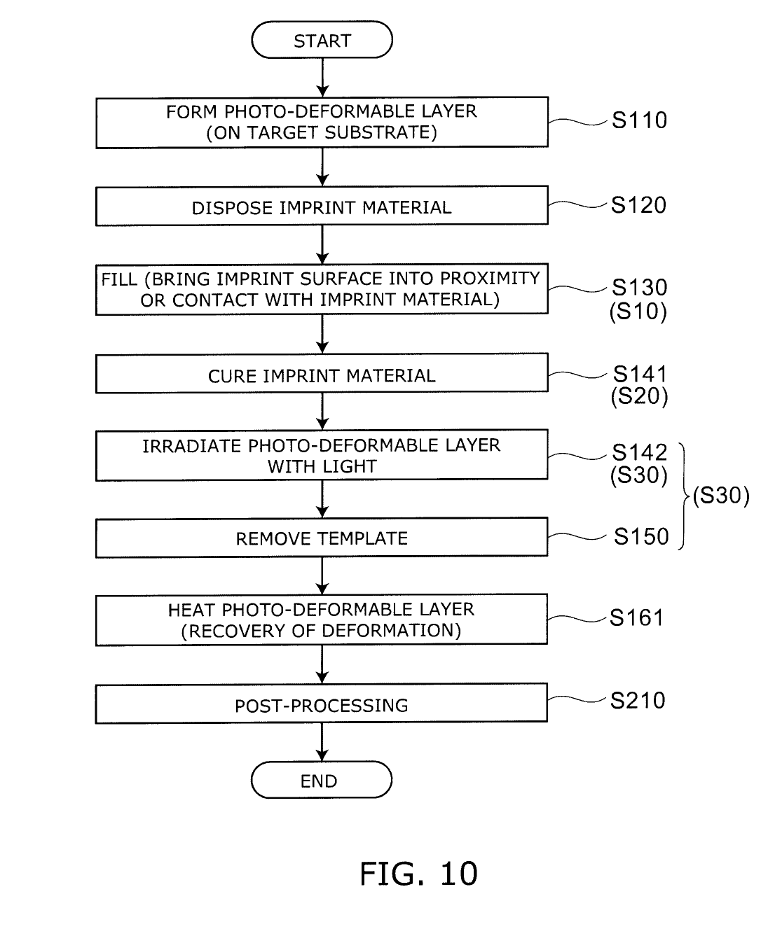

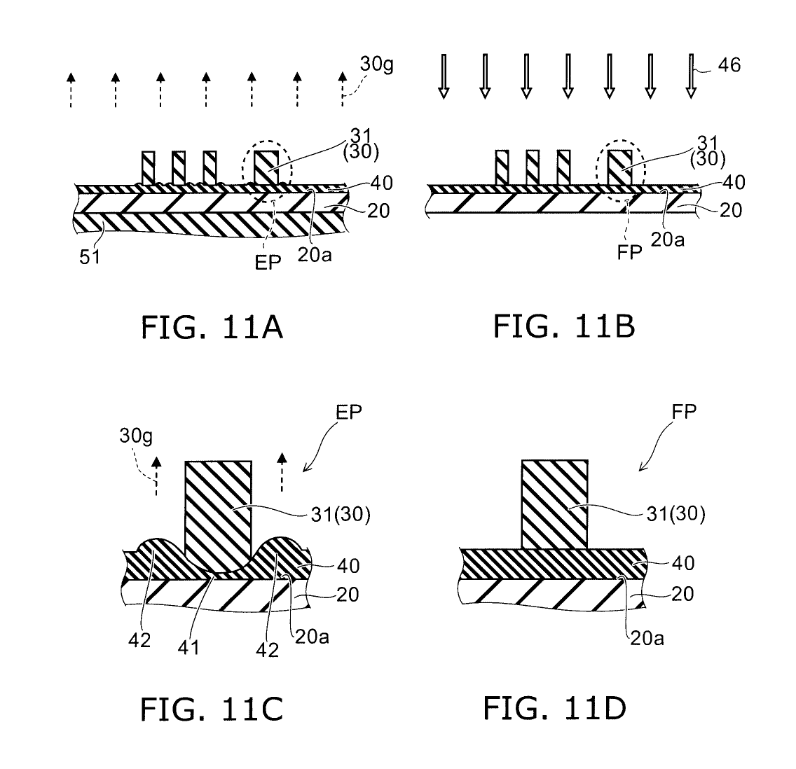

FIG. 10 is a flowchart illustrating the pattern forming method according to the fourth example. FIGS. 11A to 11D are schematic cross-sectional views illustrating the pattern forming method according to the fourth example.

Specifically, FIGS. 11A and 11B are schematic cross-sectional views of a processing procedure, FIG. 11C is an enlarged schematic cross-sectional view of a portion EP in FIG. 11A, and FIG. 11D is an enlarged schematic cross-sectional view of a portion FP in FIG. 11B.

As illustrated in FIG. 10, in the pattern forming method according to the fourth example, Step S110, Step S120, Step S130, Step S141, Step 142, and Step S150 are the same as those of the third example. Thus, a description thereof will be omitted.

As illustrated in FIG. 10 and FIG. 11A, in the pattern forming method according to the fourth example, Step 160 (irradiation of the photo-deformable layer 40 with the light 46) of the third example is replaced with the heating of the photo-deformable layer 40 (Step S161). For example, after removal of the template 10, the target substrate 20 is mounted on a hotplate 51 and heated. The target substrate is, for example, heated at 100° C. for 30 minutes.

As a result, the recesses and protrusions (the recess portions 41 and the protrusion portions 42) in the photo-deformable layer 40 formed in Step S142 are removed, the deformation of the photo-deformable layer 40 is recovered, and the photo-deformable layer 40 becomes substantially flat. During the heating, the residual imprint material 30 evaporates and becomes the imprint material gas 30g, and the imprint material 30 is removed from the photo-deformable layer 40.

Specifically, as illustrated in FIG. 11C, after Step S150, the recess portions 41 and the protrusion portions 42 remain in the photo-deformable layer 40. In Step S161, the photo-deformable layer 40 is restored to the initial flat state thereof by being heated. This process improves the precision of the cured imprint layer 31. However, as described above, the recesses and protrusions of the photo-deformable layer 40 may be left as is. Therefore, Step S161 may not be performed. The practice of Step S161 is arbitrary.

In the pattern forming method according to the fourth example as well, the photo-deformable layer 40 is used. By forming the recess portions 41 and the protrusion portions 42 in the photo-deformable layer 40, spaces between the recess portions 12a of the template 10 and the cured imprint layer 31 are formed. Thereby, release is accelerated, and defects at release can be suppressed.

In this case as well, the post-processing (Step S210) may further be performed.

Moreover, in the pattern forming method of the fourth example, Step S160 (irradiating with the light 46) may further be performed after Step S161 (heating).

Specifically, after release, the pattern forming method according to the embodiment performs at least one of the irradiation of the photo-deformable layer 40 with light and the heating of the photo-deformable layer 40 and may further includes a recovering process (e.g., Step S160 and Step S161) in which the deformation of the photo-deformable layer 40 is recovered by irradiation with light that has intensity varying within a plane parallel to the imprinting surface 10a.

Also, various modifications can be made to the first to fourth examples.

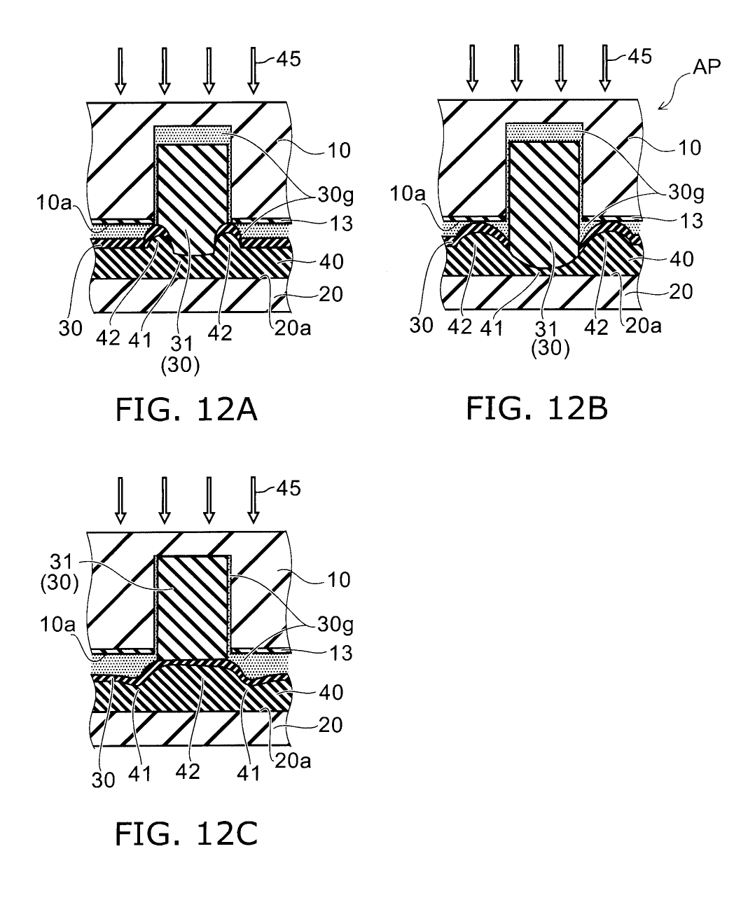

FIGS. 12A to 12C are schematic cross-sectional views illustrating a pattern forming method according to variation examples of the examples.

Specifically, FIGS. 12A to 12C are schematic cross-sectional views showing variation examples relating to the processes illustrated in , for example, FIG. 5H and FIG. 7C.

In the examples illustrated in FIG. 5H and FIG. 7C, the protrusion portions 42 of the photo-deformable layer 40 are formed more on the protrusion portions 12b side than the boundary portions between the recess portions 12a and the protrusion portions 12b of the template 10. However, as illustrated in FIG. 12A, the protrusion portions 42 of the photo-deformable layer 40 may be formed more in the boundary portions between the recess portions 12a and the protrusion portions 12b of the template 10, or more on the recess portions 12a side than the boundary portions.

In other words, the intensity distribution of light used to irradiate the photo-deformable layer 40 does not always match the pattern form of the light-blocking film 13 because of the pattern form of the recess portions 12a and the protrusion portions 12b of the recesses and protrusions 12 of the template 10, the width and depth (heights) of each of the recesses and protrusions, the characteristics of the provided light-blocking film 13, and the like. For example, with respect to the pattern form of the light-blocking film 13, a light-intensity distribution may be formed that has been subjected to near-field modulation. Therefore, although the pattern form (a form when viewed along the Z-axis direction) of the protrusion portions 42 and the recess portions 41 of the photo-deformable layer 40 reflects the pattern form (a form when viewed along the Z-axis direction) of the boundary portions between the recess portions 12a and protrusion portions 12b of the template 10, the pattern form of the protrusion portions 42 and the recess portions 41 of the photo-deformable layer 40 need not necessarily match the boundary portions of the recess portions 12a and the protrusion portions 12b of the template 10.

Further, although a case in which the light-blocking film 13 was provided on the protrusions 12b of the template 10 was described above, the light-blocking film 13 need only be provided where necessary. Even if the light-blocking film 13 is not provided on the protrusion portions 12b of the template 10, the characteristics of the light passing through the template 10 are different as a result of the difference in thicknesses of the recess portions 12a and the protrusion portions 12b. Also, reflection of the light 45 occurs at wall surfaces of the recess portions 12a (which also constitute wall surfaces of the protrusion portions 12b) of the template 10, and the characteristics of the light 45 passing at the boundary portions between the recess portions 12a and protrusion portions 12b of the template 10 differ from those at the recess portions 12a and the protrusion portions 12b.

For example, refraction phenomena occurs as a result of a periodic structure of the recess portions 12a and protrusion portions 12b, and the intensity of the light 45 varies in the surface (X-Y plane) parallel to the imprinting surface 10a. As a result, the imprinting surface 10a is irradiated with the light 45 that has intensity varying within the surface (X-Y plane) parallel to the photo-deformable layer 40, and the recess portions 41 and the protrusion portions 42 are formed in the photo-deformable layer 40. In this case as well, spaces are formed between the recess portions 12a of the template 10 and the cured imprint layer 31. Thereby, release is accelerated, and defects at release can be suppressed.

Moreover, although the first to fourth examples described a case in which the recess portions 41 are formed in the light-irradiated regions 40R and the protrusion portions 42 are formed in the adjacent regions 40S, a material with the reverse of these characteristics may be used as the photo-deformable material.

Specifically, as illustrated in FIG. 12C, the regions of the photo-deformable layer 40 corresponding to the recess portions 12a, where the light-blocking film 13 is not provided may become the protrusion portions 42; and the regions of the photo-deformable layer 40 corresponding to the protrusion portions 12b, where the light-blocking film 13 is provided may become the recess portions 41. The formation of the recess portions 41 and the protrusion portions 42 causes separation of the imprint material 30 from the protrusion portions 12b of the template 10, causes the side surfaces in the recess portions 12a of the template 10 and the cured imprint layer 31 within the recess portions 12a to act upon each other, and accelerates release.

A configuration in which a photo-deformable material with such characteristics is used without providing the light-blocking film 13 may also be used. In this case, the recess portions 41 and the protrusion portions 42 are formed in the photo-deformable layer 40 by modulations of the intensity of the light 45 based on the recesses and protrusions 12 of the template 10, thereby accelerating the release of the cured imprint layer 31 from the template 10.

Thus, the photo-deformable layer 40 used in the pattern forming method according to the embodiment may be any material as long as the state of recesses and protrusions of a surface thereof varies depending on the intensity of the light with which it is irradiated. It is necessary only that the release of the cured imprint material 30 (the cured imprint layer 31) from the imprinting surface 10a (Step S30) is conducted by irradiating the photo-deformable layer 40 with the light 45 having intensity varying within a plane parallel to the imprinting surface 10a so as to deform the photo-deformable layer 40.

In the third and fourth examples, the light 35 is used to cure the imprint material 30 and the light 45 is used to deform the photo-deformable layer 40. The light for curing the imprint material 30 and the light for deforming the photo-deformable layer have different wavelengths (wavelength characteristics). However, in the third and fourth examples, the light 44 of the same wavelength (identical wavelength characteristics) may be used to cure the imprint material 30 and deform the photo-deformable layer 40, as in the second example.

### FIFTH EXAMPLE

In a pattern forming method of a fifth example according to the embodiment, the photo-deformable layer 40 is provided on the imprinting surface 10a of the template 10. Specifically, the filling is performed in a state in which the photo-deformable layer 40 is interposed between the imprinting surface 10a and the imprint material 30.

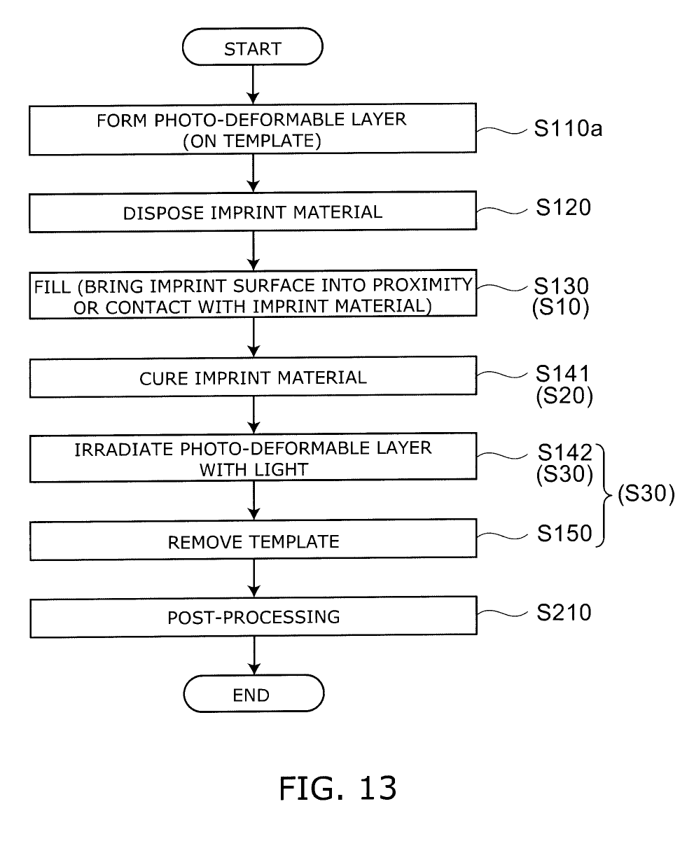

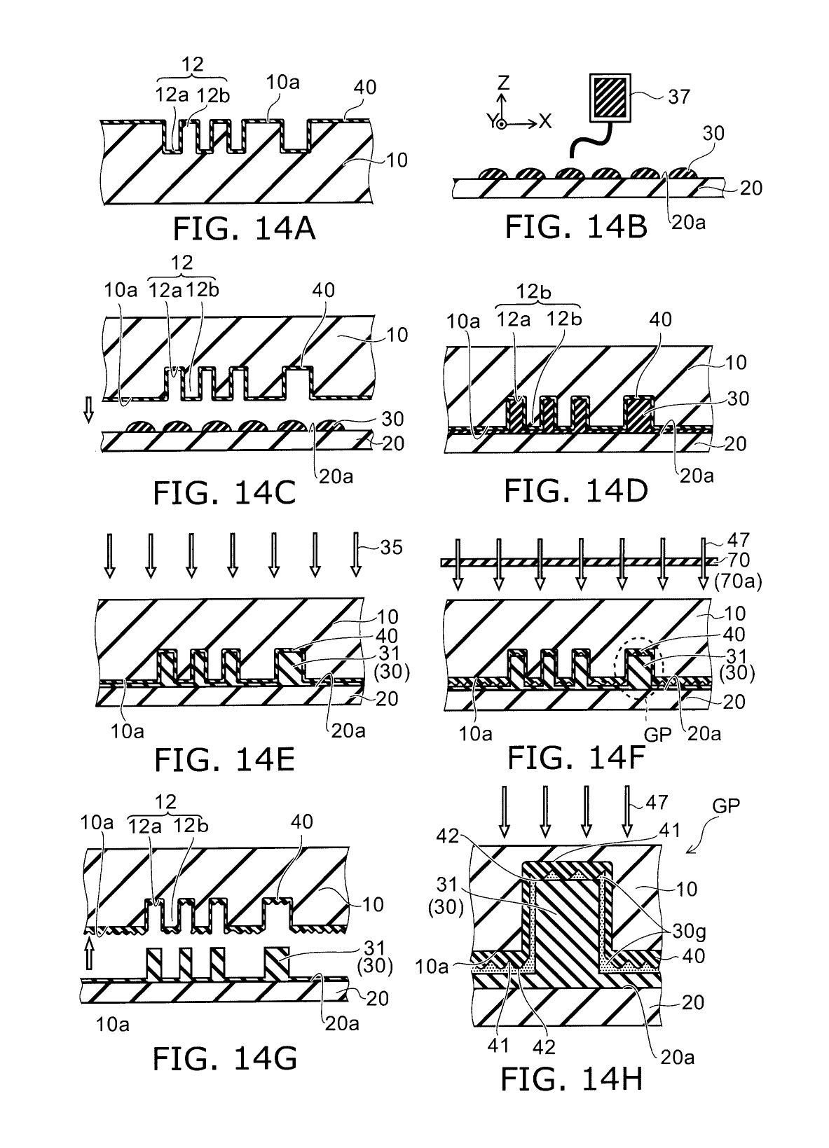

FIG. 13 is a flowchart illustrating the pattern forming method according to the fifth example. FIGS. 14A to 14H are schematic cross-sectional views illustrating the pattern forming method according to the fifth example.

More specifically, FIGS. 14A to 14G are schematic cross-sectional views of a processing procedure, and FIG. 14H is an enlarged schematic cross-sectional view of a portion GP in FIG. 14F.

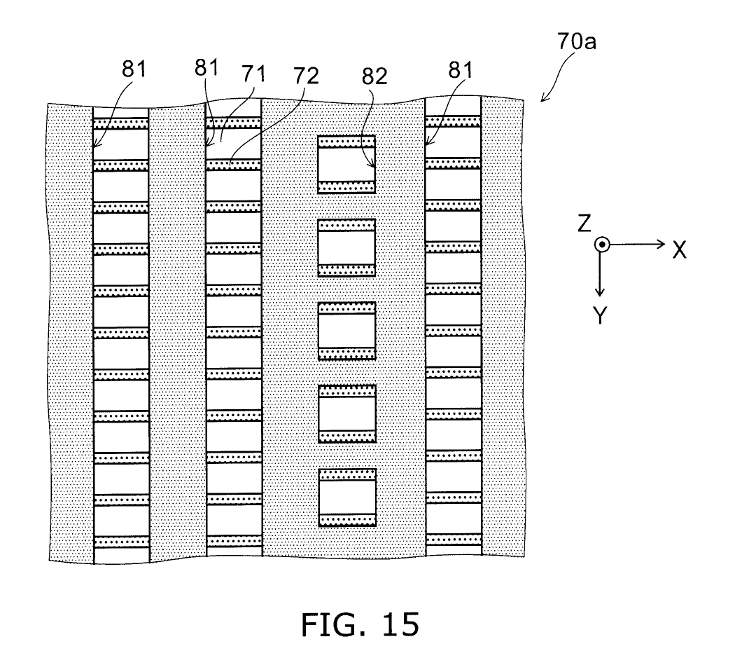

FIG. 15 is a schematic plan view illustrating an irradiation pattern of light used in the pattern forming method according to the fifth example.

As illustrated in FIG. 13 and FIG. 14A, in the pattern forming method according to the fifth example, the photo-deformable layer 40 is formed on the imprinting surface 10a of the template 10 (Step S110a). The photo-deformable layer 40 is formed on inner surfaces of the recess portions 12a of the template 10 and over an entire surface of the protrusion portions 12b. In the case where the template 10 with the photo-deformable layer 40 provided on the imprinting surface 10a is prepared in advance, Step S110 may be omitted.

As illustrated in FIG. 13 and FIG. 14B, the imprint material 30 is disposed on the major surface 20a of the target substrate 20 (Step S120).

Subsequently, as illustrated in FIG. 13 and FIG. 14C, the imprinting surface 10a of the template 10 is set to face the imprint material 30 provided on the major surface 20a of the target substrate 20.

Then, as illustrated in FIG. 13 and FIG. 14D, the imprinting surface 10a is brought into proximity to or contact with the imprint material 30 (Step S130). In this specific example, the imprinting surface 10a is brought into proximity to the imprint material 30 via the photo-deformable layer 40. As a result, the imprint material 30 fills the recess portions 12a of the recesses and protrusions 12 (Step S10). The filling is performed in a state in which the photo-deformable layer 40 is interposed between the imprinting surface 10a of the template 10 and the imprint material 30.

Then, as illustrated in FIG. 13 and FIG. 14E, in a state in which the imprint material 30 fills the recess portions 12a, the imprint material 30 is cured (Step S141). Specifically, the imprint material 30 is irradiated with light 35 that has, for example, a peak wavelength of approximately 300 nm for curing the imprint material 30 and an intensity of approximately 200 mJ/cm². By the irradiation with the light 35, the imprint material 30 is cured, and the cured imprint layer 31 is formed.

Thereby, the pattern of the recesses and protrusions 12 is imprinted, and the imprint material 30 is formed into the cured imprint layer 31.

Then, as illustrated in FIG. 13 and FIG. 14F, the photo-deformable layer 40 is irradiated with light 47 (Step S142). The light 47 has a wavelength and energy for deforming the photo-deformable layer 40. The light 47 has, for example, a peak wavelength of approximately 400 nm and an intensity of approximately 80 mW/cm². In addition, the light 47 is light that has intensity varying within the plane parallel to the imprinting surface 10a (X-Y plane).

For example, the photo-deformable layer 40 is irradiated with the light 45 via the filter 70 having light-passing portions 71 and light-blocking portions 72, such as that illustrated in FIG. 3A. As a result, the intensity of the light 47 varies within the X-Y plane.

As illustrated in FIG. 15, the light-passing portions 71 and the light-blocking portions 72 having a pattern corresponding to the pattern of the recesses and protrusions 12 of the template 10 may be provided in a filter 70a. The filter 70a is one of the variation examples of the filter 70 illustrated in FIG. 3.

In this specific example, the pattern of the recesses and protrusions 12 of the template 10 includes a stripe-shaped pattern 81 aligned, for example, in the Y-axis direction, and an island pattern 82 divided in the X-axis direction and the Y-axis direction. The pattern of the light-passing portions 71 and the light-blocking portions 72 of the filter 70a are a band form aligned in the X-axis direction. Specifically, for example, an aligned direction (Y-axis direction) of the stripe-shaped pattern 81 of the recesses and protrusions 12 of the template 10 is perpendicular (non-parallel) to an aligned direction of a plurality of alternately arranged, band-form light-passing portions 71 and light-blocking portions 72. Also, in this specific example, the light-blocking portions 72 are provided in both edge portions of the island pattern of the recesses and protrusions 12 of the template 10 in the Y-axis direction, and the light-passing portions 71 are provided in a central portion.

However, the above-described arrangement is one example, and the embodiments are not limited thereto. The pattern form of the light-passing portions 71 and the light-blocking portions 72 is arbitrary. Additionally, the light-passing portions 71 may be provided in the both edge portions of the island pattern of the recesses and protrusions 12 of the template 10 in the Y-axis direction, and the light-blocking portions 72 may be provided in the central portion.

By using such a filter 70a (or the filter 70 illustrated in FIG. 3A), the intensity of the light 47 varies within the X-Y plane. Hence, as illustrated in FIG. 14H, the recess portions 41 and the protrusion portions 42 are formed in the photo-deformable layer 40 based on the variations in the intensity of the light 47.

FIG. 14H is schematically illustrated, and therefore, the dispositions and aligned directions of the recess portions 12a and the protrusion portions 12b of the template 10 and the dispositions and aligned directions of the recess portions 41 and protrusion portions 42 of the photo-deformable layer 40 shown in FIG. 14H do not necessarily match the actual dispositions and aligned directions.

For example, the top surface of the cured imprint layer 31 is pushed downward (a direction from the template 10 toward the target substrate 20) by the bottom surfaces of the protrusion portions 42 of the photo-deformable layer 40.

As a result, the template 10 and the cured imprint layer 31 are separated from each other without applying an external mechanical force. In this way, the photo-deformable layer 40 is irradiated with the light 45, the photo-deformable layer 40 is deformed, and the cured imprint material 30 (the cured imprint layer 31) is released from the imprinting surface 10a (Step S30).

Then, as illustrated in FIG. 13 and FIG. 14G, the template 10 is removed (Step S150). At this time, the template 10 and the cured imprint layer 31 have been separated from each other as a result of the deformation of the photo-deformable layer 40, and thus separate from each other without applying an external mechanical force. Therefore, when the template 10 is removed, the cured imprint layer 31 is not damaged and the occurrence of defects is suppressed.

In this way, the pattern forming method according to the fifth example can also provide a nanoimprint pattern forming method that suppresses defects at release.

As illustrated in FIG. 13, this case can also perform post-processing (Step 210) in which the thickness of the cured imprint layer 31 after imprinting is reduced to expose a part of the major surface 20a of the target substrate 20.

### SIXTH EXAMPLE

In a pattern forming method of a sixth example according to the embodiment, the photo-deformable layer 40 is irradiated with light after the removal of the template 10, and the deformation of the photo-deformable layer 40 is recovered.

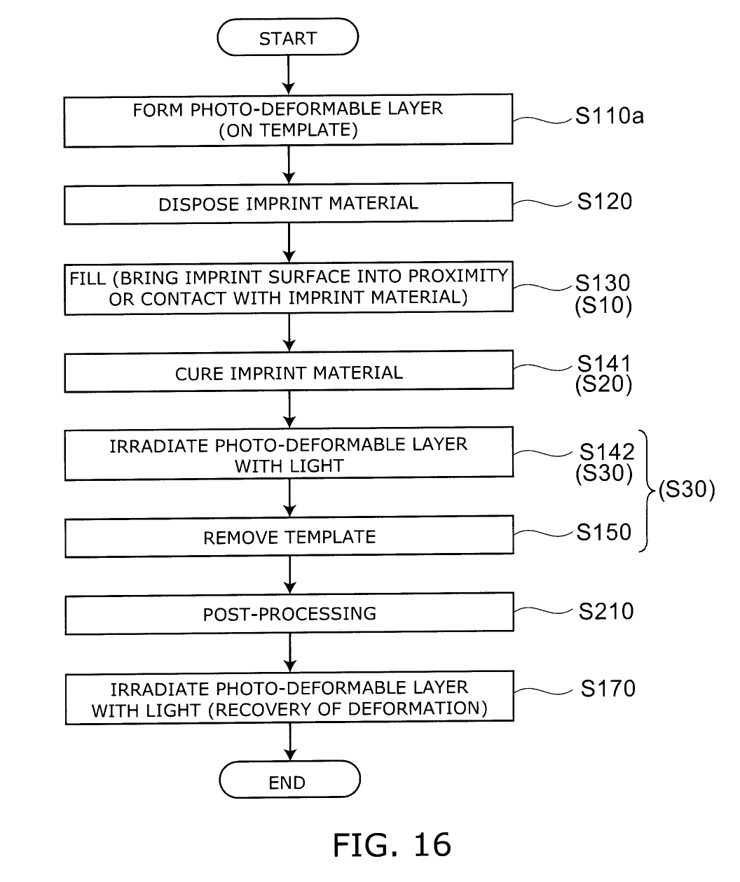

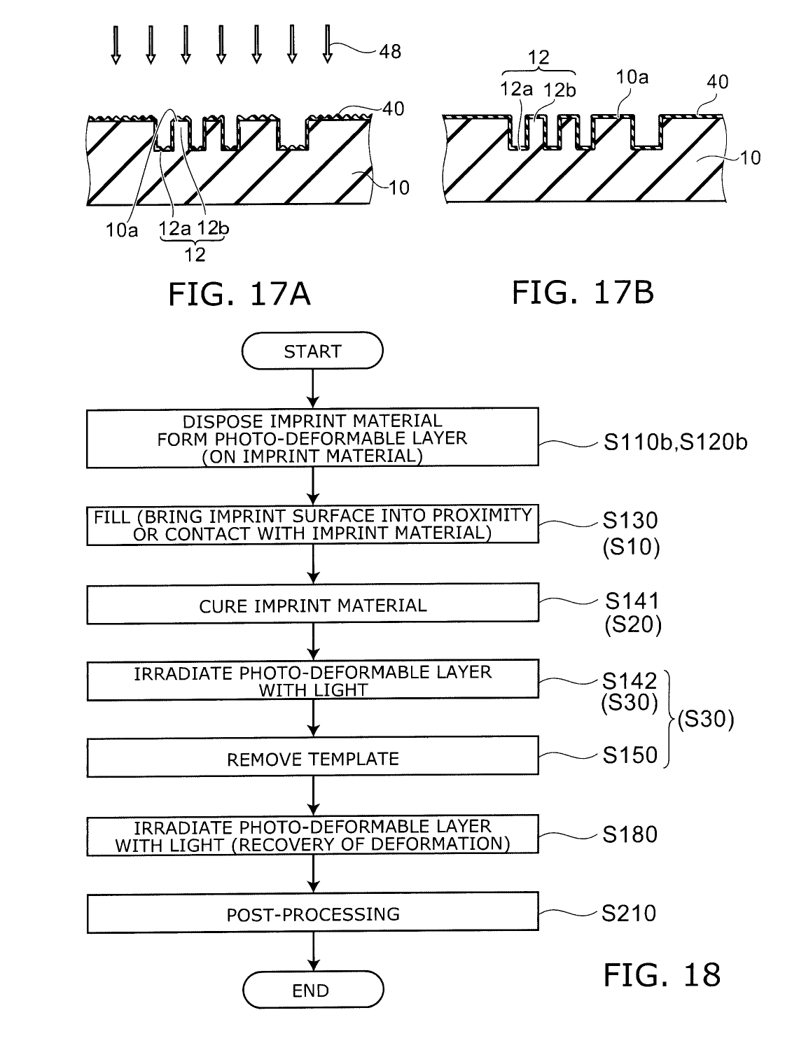

FIG. 16 is a flowchart illustrating the pattern forming method according to the sixth example. FIGS. 17A and 17B are schematic cross-sectional views illustrating the pattern forming method according to the sixth example.

As illustrated in FIG. 16, in the pattern forming method according to the sixth example, after removing the template 10 in the fifth example (Step S150), the photo-deformable layer 40 provided on the template 10 is irradiated with light, and the deformation of the photo-deformable layer 40 is recovered (Step S170).

In FIG. 16, Step S210 can be omitted. Also, in the case where Step S210 is performed, the order of Step S210 and Step S170 is arbitrary.

Specifically, the photo-deformable layer 40, having the template 10 removed, is irradiated with light 48 as illustrated in FIG. 17A. The irradiation is performed, for example, over the entire surface of the photo-deformable layer 40.

Hence, as illustrated in FIG. 17B, the recesses and protrusions (the recess portions 41 and the protrusion portions 42) formed in the photo-deformable layer 40 are removed, and the deformation of the photo-deformable layer 40 is recovered. Thus, the template 10 in which the deformation has been recovered can be used in Step S130 and can be repeatedly used for multiple imprints.

In this example, the deformation of the photo-deformable layer 40 may be recovered by heating the template 10 instead of Step S170 in which the photo-deformable layer 40 provided on the template 10 is irradiated with light to recover the deformation of the photo-deformable layer 40.

### SEVENTH EXAMPLE

In a pattern forming method of a seventh example according to the embodiment, the photo-deformable layer 40 is provided on an top surface of the imprint material 30 of the target substrate 20 (the surface on a side opposite to the imprinting surface 10a of the template 10).

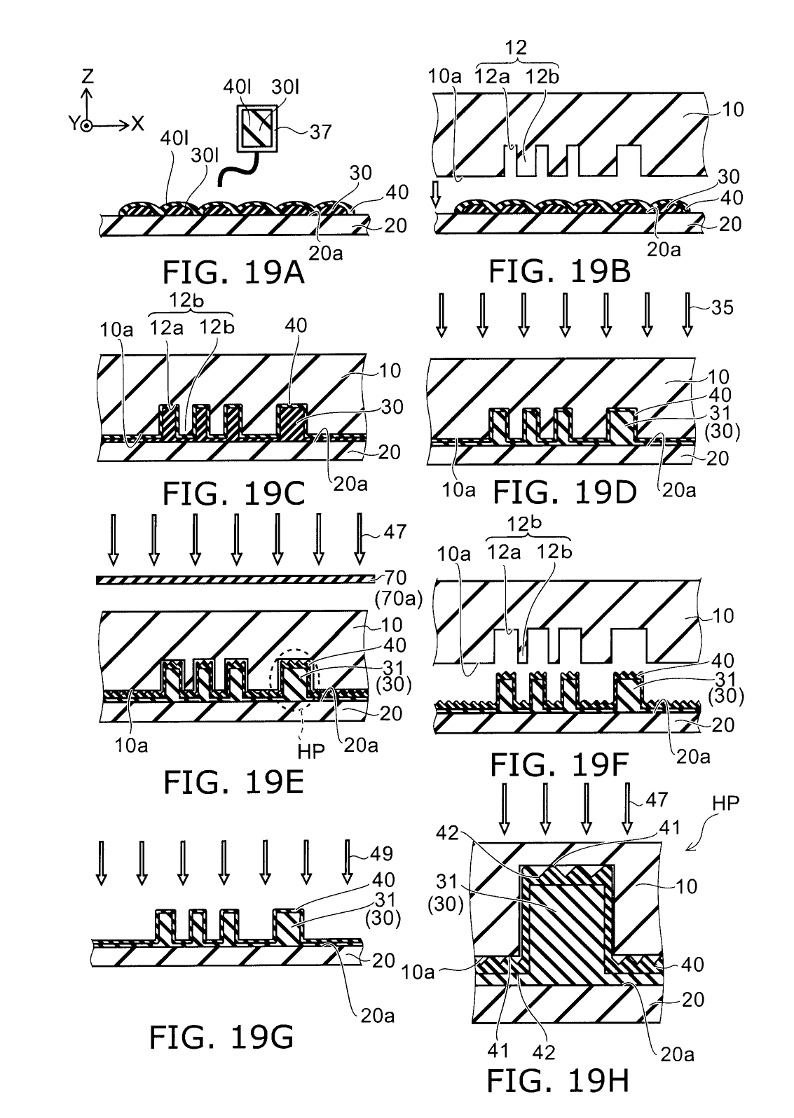

FIG. 18 is a flowchart illustrating the pattern forming method according to the seventh example. FIGS. 19A to 19H are schematic cross-sectional views illustrating the pattern forming method according to the seventh example.

Specifically, FIGS. 19A to 19G are schematic cross-sectional views of a processing procedure, and FIG. 19H is an enlarged schematic cross-sectional view of a portion GP in FIG. 19E.

As illustrated in FIG. 18 and FIG. 19A, in the pattern forming method according to the seventh example, the imprint material 30 is deposited on the major surface 20a of the target substrate 20 (Step S120b) along with forming the photo-deformable layer 40 on the imprint material 30 (Step S110b). In other words, Step S110b and Step S120b are performed simultaneously.

For example, a mixed liquid obtained by mixing a photo-curable resin liquid 301 that is to become the imprint material 30 and a photo-deformable material liquid 401 that is to become the photo-deformable layer 40 is coated on the major surface 20a of the target substrate 20 using, for example, a dispenser 37. By appropriately adjusting characteristics including such as, for example, compatibility and surface tension of the above-described photo-curable resin liquid 301 and the above-described photo-deformable material liquid 401, the photo-curable resin liquid 301 and the photo-deformable material liquid 401 are caused to separate after the mixed liquid is coated onto the target substrate 20. As illustrated in FIG. 19A, the photo-curable resin liquid 301 is disposed on the target substrate 20 side and the photo-deformable material liquid 401 is disposed on a side opposite to the target substrate 20. As a result, the imprint material 30 is disposed on the major surface 20a of the target substrate 20, and the photo-deformable layer 40 is formed on the imprint material 30.

Subsequently, as illustrated in FIG. 18 and FIG. 19B, the imprinting surface 10a of the template 10 is set to face the imprint material 30 (and the photo-deformable layer 40) provided on the major surface 20a of the target substrate 20.

Then, as illustrated in FIG. 18 and FIG. 19C, the imprinting surface 10a is brought into proximity to or contact with the imprint material 30 (Step S130). In this specific example, the imprinting surface 10a is brought into proximity to the imprint material 30 via the photo-deformable layer 40. As a result, the recess portions 12a of the recesses and protrusions 12 are filled with the imprint material 30 (Step S10). The filling is performed in a state in which the photo-deformable layer 40 is interposed between the imprinting surface 10a of the template 10 and the imprint material 30.

Then, as illustrated in FIG. 18 and FIG. 19D, in a state in which the imprint material 30 fills the recess portions 12a, the imprint material 30 is cured (Step S141). Specifically, the imprint material 30 is irradiated with light 35 that has, for example, a peak wavelength of approximately 300 nm and an intensity of approximately 200 mJ/cm² for curing the imprint material 30. By the irradiation with the light 35, the imprint material 30 is cured, and the cured imprint layer 31 is formed.

Thereby, the pattern of the recesses and protrusions 12 is imprinted, and the imprint material 30 is formed into the cured imprint layer 31.

Next, as illustrated in FIG. 18 and FIG. 19E, the photo-deformable layer 40 is irradiated with the light 47 (Step S142). The light 47 is light that has a wavelength and energy to deform the photo-deformable layer 40. The light 47 has, for example, a peak wavelength of approximately 400 nm and an intensity of approximately 80 mW/cm². The light 47 is light that has intensity varying within the plane parallel to the imprinting surface 10a (X-Y plane). For example, the photo-deformable layer 40 is irradiated via the filter 70a illustrated in FIG. 15 (or the filter 70 illustrated in FIG. 3A). As a result, the intensity of the light 47 varies within the X-Y plane.

Thereby, as illustrated in FIG. 19H, the recess portions 41 and the protrusion portions 42 are formed in the photo-deformable layer 40 based on the variation of the intensity of the light 47.

The bottom surface of the template 10 is pushed upwards (a direction from the target substrate 20 toward the template 10) by the top surfaces of the protrusion portions 42 of the photo-deformable layer 40.

As a result, the cured imprint layer 31 and the template 10 are separated from each other without applying an external mechanical force. In this way, the photo-deformable layer 40 is irradiated with the light 45, the photo-deformable layer 40 is deformed, and the cured imprint material 30 (the cured imprint layer 31) is released from the imprinting surface 10a (Step S30).

Next, as illustrated in FIG. 18 and FIG. 19F, the template 10 is removed (Step S150). At this time, the template 10 and the cured imprint layer 31 are separated from each other as a result of the deformation of the photo-deformable layer 40. Thus, the template 10 and the cured imprint layer 31 can be separated from each other without applying an external mechanical force. Therefore, the cured imprint layer 31 is not damaged when the template 10 is removed, and the occurrence of defects is suppressed.

In this way, the pattern forming method according to the seventh example can also provide a nanoimprint pattern forming method that suppresses the occurrence of defects at release.

The recesses and protrusions (the recess portions 41 and the protrusion portions 42) are formed in the photo-deformable layer 40 on the cured imprint layer 31 after removal of the template 10. To recover the recesses and protrusions of the photo-deformable layer 40, the photo-deformable layer 40 may be irradiated with light 49 as illustrated in FIG. 17 and FIG. 18G. In other words, a recovering process (Step S180) may further be performed in which the photo-deformable layer 40 is irradiated with the light 49 after the removal of the template 10 and the deformation (e.g., the recess portions 41 and the protrusion portions 42) of the photo-deformable layer caused by the above-described irradiation with the light 47 is recovered.

Additionally, in this example, a recovering process in which the deformation of the photo-deformable layer 40 is recovered by heating the photo-deformable layer 40 may be performed instead of Step S180 described above.

However, the photo-deformable layer 40 having the recesses and protrusions can be substantially removed by, for example, performing the post-processing (Step S210). Hence, after removal of the template 10, the photo-deformable layer 40 may keep the recesses and protrusions as is. Therefore, the above-described recovering process can be performed as necessary. It is possible to omit the recovering process.

After performing Step S150 described above, or after performing Step S180 after Step S150, it is possible to further perform the post-processing (Step S210) in which the film thickness of the cured imprint layer 31 after imprinting is reduced to expose a part of the major surface 20a of the target substrate 20.

In this example, as described above, Step S110b and Step S120b are performed simultaneously. In all the examples of the embodiment, each of the plurality of steps to be performed may be interchanged where it is technically possible to do so. Additionally, a multiplicity of the plurality of steps may be performed simultaneously.

In the fifth to seventh examples, the imprint material 30 was cured by irradiation with the light 35, and the photo-deformable layer 40 was deformed by irradiation with the light 47. However, the wavelength of the light 35 (wavelength characteristics) and the wavelength of the light 47 (wavelength characteristics) may be substantially the same.

In the fifth to seventh examples, the irradiation with the light 47 via the filter 70a or the filter 70 was performed to deform the photo-deformable layer 40. However, the intensity of the light 47 in the plane parallel to the imprinting surface 10a (X-Y plane) may be varied without using a filter by, for example, irradiating the template 10 with the light 47 using the effects of refraction and the like resulting from the recesses and protrusions 12 of the template 10. Here, the light-blocking film 13 need not be provided on the protrusion portions 12b of the template 10, but in some cases, the light-blocking film 13 may be provided.

In the first to fourth examples, the photo-deformable layer 40 is provided between the target substrate 20 and the imprint material 30. In the fifth and sixth examples, the photo-deformable layer 40 is provided on the imprinting surface 10a of the template 10. In the seventh example, the photo-deformable layer 40 is provided on the imprint material 30 of the target substrate 20. However, in this embodiment, the photo-deformable layer 40 may be provided at least one location of between the target substrate 20 and the imprint material 30, on the imprinting surface 10a of the template 10, and on the imprint material 30 of the target substrate 20. A plurality of the photo-deformable layers 40 may be provided in these multiple locations.

Additionally, in the first to fourth examples, the intensity of the light used to irradiate the photo-deformable layer 40 was varied in the plane parallel to the imprinting surface 10a (X-Y plane) by providing the light-blocking film 13 on the protrusion portions 12b of the template 10, making use of the difference in characteristics of the recess portions 12a and the protrusion portions 12b of the template 10, or making use of the difference in characteristics at the boundary portions between the recess portions 12a and the protrusion portions 12b and other portions. In the fifth to seventh examples, the intensity of the light used to irradiate the photo-deformable layer 40 was varied in the plane parallel to the imprinting surface (X-Y plane) using the filter 70 or the filter 70a. However, the intensity of the light used to irradiate the photo-deformable layer 40 may be varied in the plane parallel to the imprinting surface 10a (X-Y plane) using a combination of multiple techniques among such techniques.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the invention is not limited to these specific examples. For example, one skilled in the art may similarly practice the invention by appropriately selecting specific configurations of components included in pattern forming methods such as templates, target substrates, imprint materials, photo-deformable layers, and the like from known art. Such practice is included in the scope of the invention to the extent that similar effects thereto are obtained.

Further, any two or more components of the specific examples may be combined within the extent of technical feasibility; and are included in the scope of the invention to the extent that the purport of the invention is included.

Moreover, all pattern forming methods practicable by an appropriate design modification by one skilled in the art based on the pattern forming methods described above as exemplary embodiments of the invention also are within the scope of the invention to the extent that the purport of the invention is included.

Furthermore, various modifications and alterations within the spirit of the invention will be readily apparent to those skilled in the art. All such modifications and alterations should therefore be seen as within the scope of the invention. For example, additions, deletions, or design modifications of components or additions, omissions, or condition modifications of processes appropriately made by one skilled in the art in regard to the exemplary embodiments described above are within the scope of the invention to the extent that the purport of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. A pattern forming method for imprinting an imprinting surface of a template onto an imprint material provided on a major surface of a target substrate, the imprinting surface including recess and protrusion, the method comprising:
filling a recess portion of the recess and protrusion with the imprint material, a photo-deformable layer being interposed between at least one location of a location between the imprinting surface and the imprint material and a location between the target substrate and the imprint material during the filling, a configuration of the photo-deformable layer being deformable by light irradiation;
curing the imprint material, the recess portion being filled with the imprint material during the curing; and
releasing the cured imprint material from the imprinting surface by irradiating the photo-deformable layer with light and by deforming the photo-deformable layer, the light having an intensity varying within a plane parallel to the imprinting surface.

2. The method according to claim 1, wherein the intensity of the light used for the irradiating the photo-deformable layer in the releasing is varied by diffraction based on the recess and protrusion.

3. The method according to claim 1, wherein a protrusion portion of the recess and protrusion includes a light-blocking film which is configured to reduce the intensity of the light used for the irradiating the photo-deformable layer in the releasing.

4. The method according to claim 1, wherein the imprint material is a photo-curable resin, the curing is performed by irradiating the imprint material with light, and the light used for the irradiating the imprint material in the curing has a wavelength component different from a wavelength component of the light used for the irradiating the photo-deformable layer in the releasing.

5. The method according to claim 1, further comprising recovering a deformation of the photo-deformation layer formed in the releasing by performing at least one of irradiating the photo-deformable layer with light and heating the photo-deformable layer after the releasing.

6. The method according to claim 1, wherein the photo-deformable layer includes polymer including azo group.

7. The method according to claim 1, wherein the photo-deformable layer includes a main chain and a side chain, the side chain being jointed to the main chain and including azobenzene group.

8. The method according to claim 1, wherein the irradiating the photo-deformable layer with the light having the intensity varying within the plane parallel to the imprinting surface includes irradiating the photo-deformable layer with the light via a filter having a light-passing portion and a light-blocking portion.

9. The method according to claim 1, wherein a peak wavelength of the light having the intensity varying within the plane parallel to the imprinting surface is not less than 300 nanometers and not more than 500 nanometers.

10. The method according to claim 1, wherein the imprint material is a photo-curable resin, the curing is performed by irradiating the imprint material with light, and a wavelength of the light used for the irradiating the imprint material in the curing is shorter than a wavelength of the light used for the irradiating the photo-deformable layer in the releasing.

11. The method according to claim 1, wherein the filling includes:
forming the photo-deformable layer on the major surface of the target substrate;
disposing the imprint material on the photo-deformable layer; and
bringing the imprinting surface of the template into proximity or contact with the imprint material.

12. The method according to claim 1, wherein the disposing the imprint material includes disposing the imprint material by an inkjet method.

13. The method according to claim 1, wherein a protrusion portion of the recess and protrusion includes a light-blocking film which is used as a mask in forming the recess and protrusion in the imprinting surface of the template and the light-blocking film is configured to reduce the intensity of the light used for the irradiating the photo-deformable layer in the releasing.

14. The method according to claim 1, wherein at least a part of a portion of the imprint material is a liquid state in the irradiating the photo-deformable layer with the light having the intensity varying within the plane parallel to the imprinting surface, the portion of the imprint material being in contact with a protrusion portion of the recess and protrusion.

15. The method according to claim 1, wherein the releasing includes introducing gas generated by vaporization of the imprint material to a space between the template and the imprint material.

16. The method according to claim 1, further comprising performing a post-processing after the releasing to expose a part of the major surface of the target substrate, the post-processing including reducing at least a film thickness of the cured imprint material and a film thickness of the photo-deformable layer.

17. The method according to claim 1, wherein at least a part of the curing and at least a part of the releasing are simultaneously performed.

18. The method according to claim 1, wherein the filling includes:
forming the photo-deformable layer on the imprinting surface of the template;
disposing the imprint material on the major surface of the target substrate; and
bringing the imprinting surface of the template into proximity or contact with the imprint material.

19. The method according to claim 1, wherein
the recess and protrusion includes a stripe-shaped pattern aligned along a first direction parallel to the imprinting surface, and
the irradiating the photo-deformable layer with the light having the intensity varying within the plane parallel to the imprinting surface includes irradiating the photo-deformable layer with the light via a filter having a plurality of light-passing portions and a plurality of light-blocking portions aligned in a direction parallel to the imprinting surface and nonparallel to the first direction.

20. The method according to claim 1, wherein the filling includes:
applying a mixed liquid on the major surface of the target substrate, the mixed liquid including a photo-curable resin liquid and a photo-deformable material liquid, the photo-curable resin liquid serving as the imprint material, the photo-deformable material liquid serving as the photo-deformable layer; and
separating the photo-curable resin liquid and the photo-deformable material liquid.
